(19) United States
(12) Patent Application Publication
(10) Pub. No.: US 2017/0020122 A1
(43) Pub. Date: Jan. 26, 2017

(54) Electro-Invasion Treatment for Trees, Plants or Soil Influenced by Magnetic Field and its Methods

(71) Applicant: Ali Mirzakhani Nafchi, Lake Alfred, FL (US)

(72) Inventor: Ali Mirzakhani Nafchi, Lake Alfred, FL (US)

(21) Appl. No.: 15/081,826

(22) Filed: Mar. 25, 2016

Related U.S. Application Data
(63) Continuation of application No. 62/177,832, filed on Mar. 26, 2015.

(51) Int. Cl. A01M 17/00; A01G 1/00; A01G 13/10; A01M 21/04

(52) U.S. Cl. CPC A01M 17/00; A01M 21/046; A01G 1/001; A01G 13/105

(57) ABSTRACT

The present invention is related to a method for improving plant growth and reduce the effects of diseases, with environmental friendly techniques. This is a method for controlling or ending diseases and also, to perform a non-stop electromagnetic combine with invaded electrons treatment with its effective methods for soil, plants, trees and their roots region. Furthermore, high voltage electricity can control the borer insect/s, nematodes in plant, tree and in the soil under treatment. Some of the pathogens, nematodes and insect/s in the region influenced by the magnetic field, invaded by squall of electrons, can be decontaminated after the treatment. The exited and invasive electrons pass through the magnetic field region via negative terminal and will be discharged at positive discharge points which located on discharge bar. After receiving the high voltage treatment, the infected plant can be stimulated to regenerate and grow new leaves, shoots, and/or flashes that exhibit little to no symptoms of infection, depending on the voltage applied to the infected plant and the condition of the infected plant.

### STATEMENT OF NOT FUNDED OR GRANTED BY FEDERAL FUND

Hereby, it is declare that, the present disclosure hag not supported with federal money or grant.

### BACKGROUND OF THE INVENTION

This invention is related the methods of using the Electro-Invasion Treatment for Trees, Plants or Soil Influenced by Magnetic Field, to improve productivity of plants, trees and soil; more particularly, the treatment and its method's is for plant/trees and soil diseases.

In the background of research, the “Methods and Systems for High Voltage Treatment of Plants”, was disclosed, as a method to combat diseases, by Ali Mirzakhani Nafchi 2014.

Pest infestation to trees and also plants can cause severe economic loss to farmers and can adversely impact produce prices. Moreover there are no cures for some diseases so far. For example, Huanglongbing (HLB) infects citrus trees and have resulted economic loss to farmers due to crop acreage reduction, yields, and fruit quality.

The most effective nematicide (Temik G15) is no longer available. Also, in agricultural production there is a willing for pest management with environmental friendly techniques. High voltage electricity could be an alternative method for pest management in crop production which, the method is environmental friendly and inexpensive.

Borer insects may feed in the burrow beneath the bark, or deep in the heartwood. The trees infested by borer insects in severe infestations can result in the decline and death for infected trees.

### BRIEF DESCRIPTION OF THE DRAWINGS

The innovative apparatuses for “Electro-Invasion Treatment for Trees, Plants or Soil Influenced by Magnetic Field and the related Methods”, are shown in FIGS. 1 to 5 including;

FIG. 1 is the front view of an apparatus to perform “Electro-Invasion Treatment for Trees, Plants or Soil, Influenced by Magnetic Field and the related Methods” in operation mood;

FIG. 2 is the front view of the apparatus to perform “Electro-Invasion Treatment for Trees, Plants or Soil, Influenced by Magnetic Field and the related Methods” in transportation mood;

FIG. 3 is an isometric (top-right) view of the apparatus to perform “Electro-Invasion Treatment for Trees, Plants or Soil, Influenced by Magnetic Field and the related Methods” in transportation mood; including the components;

FIG. 4 is an isometric (front-right) view of the apparatus to perform “Electro-Invasion Treatment for Trees, Plants or Soil, Influenced by Magnetic Field and the related Methods” in transportation mood; including the components;

FIG. 5 is an isometric (left-front) view of the apparatus to perform “Electro-Invasion Treatment for Trees, Plants or Soil, Influenced by Magnetic Field and the related Methods” in operation mood; including the components.

### DETAILED DESCRIPTION OF THE INVENTION

(Notice: In this section, sometimes, the word ‘apparatus’ used as brief form of apparatus to perform “Electro-Invasion Treatment for Trees, Plants or Soil, Influenced by Magnetic Field and its Methods”)

The electro-magneto-invasion treatment is to reduce the destructive effects of infection, pest or animal damage control. However, it is contemplated to apply the treatment for trees and plants stimulation, breaking dormancy, which may results advance and off-season (extra time blooming). Moreover, the Electro-magneto-Invasion Treatment and its Methods are to increase the efficiency of production in different ways.

It is also, contemplated to apply the electro-magneto-invasion (treatment and its methods) to eliminate or reduce the infection level of diseases like HLB in the citrus and nematodes in treated soil. Likewise, it is expected that, the treatments and the methods will cover the root system as well.

The invention description in details, can be classified into three classes;

Electro-invasion treatment for trees influenced by magnetic field as an individual tree attachment or handy portable device for gardening;

Electro-invasion treatment for trees/plants canopy and root system, influenced by magnetic field and its methods;

Electro-invasion treatment for soil influenced by magnetic field and its methods.

The present disclosure, describes various embodiments for systems, devices, and methods to perform electron-invasion treatment for the trees, plants or soil whilst influenced by an electromagnetic field which included but not limited to:

On-the-go treatment for diseases or infection level in soil, plants, trees and their roots;

Control the insect, nematodes in plant, tree and in the soil;

Stimulate the plants and trees activity and increase the productivity;

Control and manage of the tree/plants dormancy and advance or late flowering to have extra and double time off-season blooming.

Fixed attachment device for a tree to stimulate the activity and also, to combat diseases, low temperature, insects and animal damage.

Diseases pathogen, nematodes and insects in the region influenced by the magnetic field, invaded by squall of electrons, can be decontaminated after the treatment.

### DETAILED DESCRIPTION OF THE DRAWING

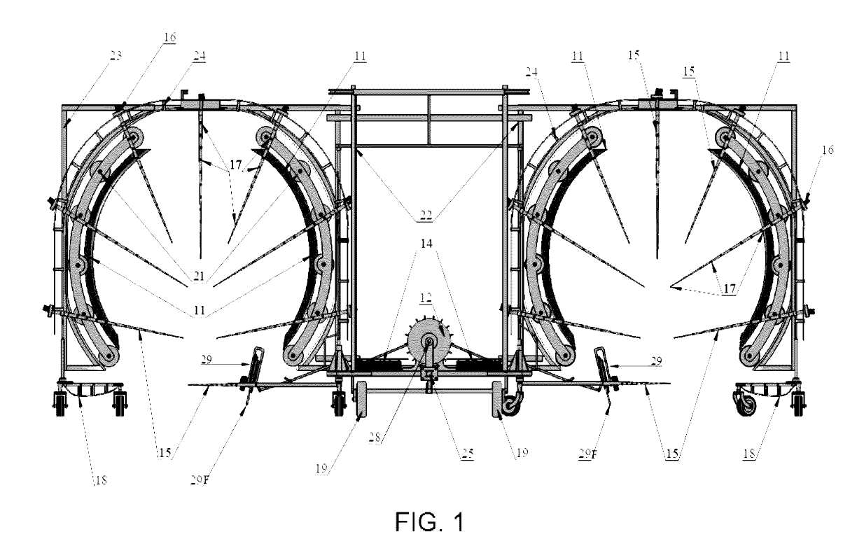

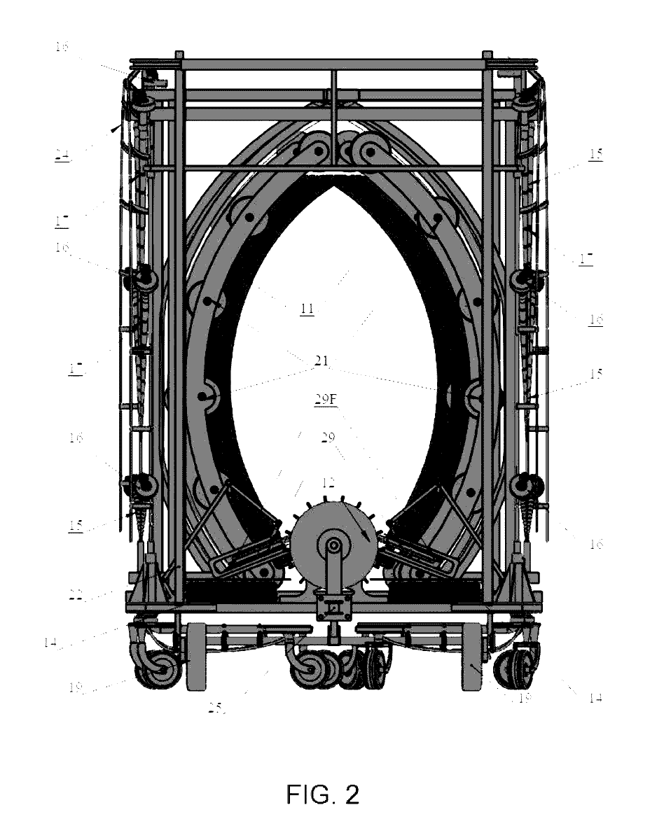

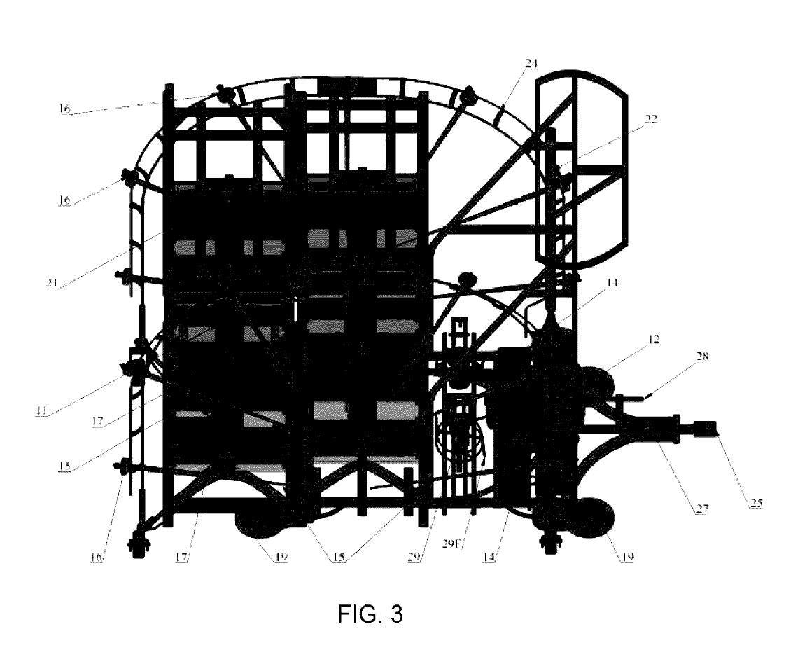

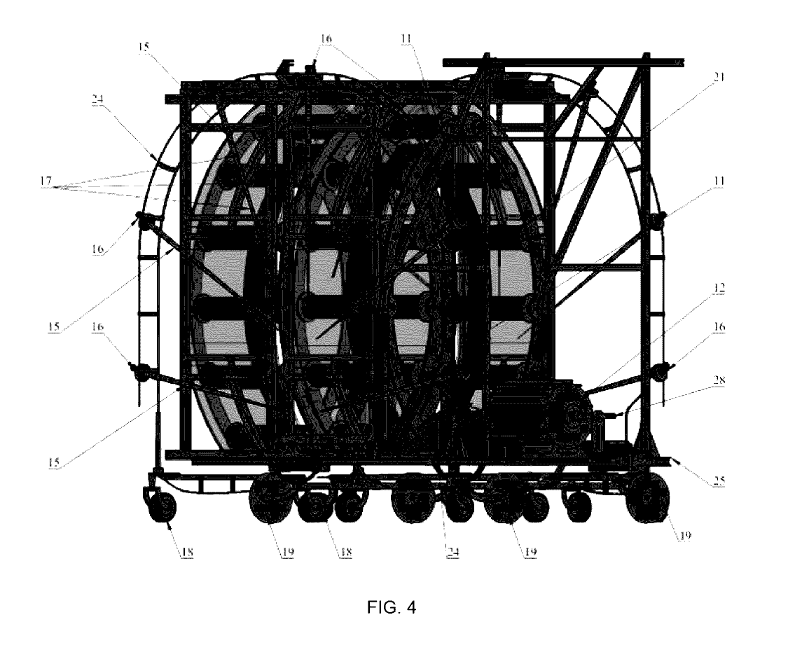

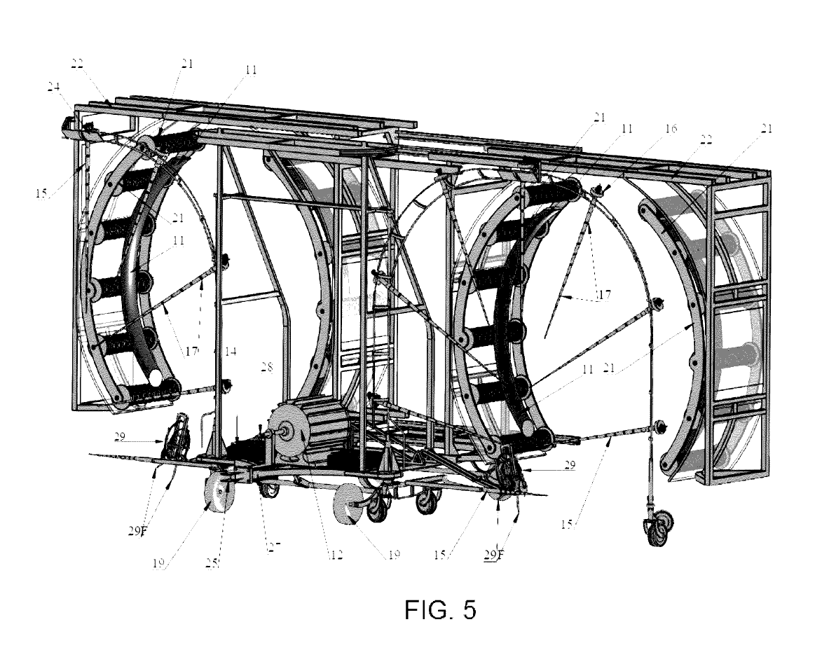

Referring now to the invention, FIGS. 1 to 5, showed more details about apparatus components of Electro-Invasion treatment for Trees, Plants and Soil, influenced by an Electromagnetic Field and related Methods.

In one embodiment, among others, a method for reducing plant, tree and soil infections comprises establishment of a magnetic field region in core, and around the tree or plant canopy, followed by inducing an invasive electricity current into the plant or tree through magnetic field.

To perform the Electro-Invasion treatment for soil, influenced by electromagnetic field, consider that, the magnetic fields is established on ground surface, in which the magnetic field deflected and concentrated into the certain soil section or region. Simultaneously, the magnetic region will be invaded by storm of electrons by an electricity current through the electrical conductivity of the soil and the existing particles through.

The magnetic field can be a consistently stabilized magnetic field with no frequency of pulsation, convertible to a magnetic field with higher frequency. Meanwhile, the invasion of the storm of electrons can be as steadily current with zero frequency, variable to pulsation mood with a higher frequency.

The apparatus designed to perform “electromagnetic combine with invasive electrons treatment for trees as an individual tree attachment or a portable handy device, comprises but not limited to; an electromagnetic or even a natural magnetic bar in which, creates a magnetic field in core and around the tree trunk. However, the tree electro-magneto-invasion attachment bar, is extensible to the some of the tree branches, or in handy device can be moved inside the canopy.

Concurrently, by having the magnetic field influenced the tree trunk and maybe branches, the electrons flow through the tree trunk or the tissues, although, the current can be a weak electricity current (for example; high voltage low amperage).

Likewise, in the tree an electro-magneto-invasion attachment, for an electromagnetic joint with invasive electrons treatment, both, the magnetic field and the invaded electrons (storm of current flow), can be continuous close circuit with no frequency, which is, convertible to a mood of higher frequency, with frequented pulsation.

The positive terminal charge of the electricity source is connected to the distributor unit for programming the frequency and timing of pulsation as desire level if needed. The negative terminal charge is connected to the roots via soil particles or to the collar, while, the positive discharge points via distributor or controller are placed around the trunk.

The negative terminal charge can be located on the ground wheel fingers to induce the storm of electron into the magnetic field via electrical conductivity of the soil and the plant/tree's tissues. Also, invasive electrons can pass through the soil and the plant roots system.

In the electro-magneto-invasion treatment, the exited and the invaded electrons pass through the electromagnetic field (region) via the negative terminal charge and will be discharged at positive discharge points which located on discharge bar in variable distance.

The discharge bars for the soil treatment can move inside the soil, whereas, the discharge bars for the trees and plants treatment can move inside the tree's canopy or crop to complete the high voltage pulses circuit.

For example, a positive terminal of a direct current (high voltage low amperage) can be connected to a discharge bar unit, moves among the crop and between the branches, while, a negative terminal will be connected to a ground terminal (soil, root section) to make a storm flow of electrons via plant/tree body or soil particles which are under influence of an electromagnetic field.

An arc of spark caused by exited and invaded electrons due to high voltage energy, can then discharge from the soil particles, plants and the trees to the corresponding positive discharge points (placed on discharge bar), or vice versa.

As the discharge bars move among the soil and crop/tree canopy, the discharge points on the discharge bar, always being relocated in-between the soil particles and among the crop/tree canopy. Consequently, the newer correspondence discharge points will be stablished on/in the subject under treatment.

Therefore, by moving the discharge bar among the treated subject there would be infinity numbers of points which the invaded electrons can be discharged. The components for the soil electro-magneto-invasion apparatus can be mounted on a cultivator or chisel (soil-seed bed preparation machinery).

Furthermore, the discharge bars themselves can be equipped by magnetic coil which; in this case an electro-magnetic field will be created surrounding the discharge bars by its electromagnetic coil, and an electromagnetic field with higher energy can be stablished.

In the designed apparatus; “electromagnetic field joint with invaded electrons as an individual tree attachment”, the immobile discharge bar/s is attached to tree trunk or some of the branches. The weaker magnetic field is created in core and surrounding the trunk and may extend to some of branches as per requirement.

The discharge points of tree electro-magneto-invasion attachment are located on the discharge bar which, will be connected to the trunk. Likewise, the correspondence discharge points, are the tree body cells.

It is to be noted that, the number of the discharge points, the pulsation frequency of the magnetic field and the electricity characteristics on discharge bar can be varied. An electricity-magnetic tree attachment apparatus can potentially, stimulate the tree activities and productivity, this apparatus as a part of the invention is a method for controlling and alternatively, to reduce the destructive effects of diseases and combat destructive low or freezing temperature effects on the tree.

Consider that, a solar panel with a reserve battery can be used as the energy source. In the order to use the methods of the electro-invasion combine with electromagnetic field, preferably, a controller kit comprises of sensor/s and controller/s is used. The controller kit is to control the voltage, amperage, resistance, frequency of pulses, magnetic field parameters, and the temperature of device as well as the treated subjects. The controller kit can be as simple as a device to change the current parameters and control the temperature in desire level.

In the methods of using the tree/soil or crop electro-magneto-invasion treatment, a positive terminal of a direct current voltage source can be connected to discharge bar/s unit while a negative terminal of the DC voltage source can be connected to a ground terminal through the roots, to invade the subject influenced by magnetic field with storm of electrons. Alternatively, the negative terminal of the DC voltage source, can be connected to the discharge bar/s through a controller and distribution unit while the positive terminal of the DC voltage source can be connected to the ground terminal.

The discharge bars and the related units comprises, but not limited to; controller, distributor, ignition coil (to generate high voltage electricity), and the magnetic coil (to create magnetic field).

By using the electro-magneto-invasion treatment, high voltage and storm of electrons flow through the subjects under treatment (soil, plant/tree and the roots system) whilst, influenced by magnetic field. The said treatment can stimulate growth, break and disrupt ion bonds in a pathogens or destruct the nematodes in soil or plants. Also, the mentioned treatment (invasive electrons inducing into a magnetic field, through and via the plants, trees and their roots system), can inhibit and/or destroy bacteria and/or pathogens.

The characteristic of the invasive electricity (invaded storm of electrons), comprises; type of current (AC/DC), level of voltage, amperage, duration and the frequency of the pulsation can be adjusted to a desire level, to perform the treatment but not to be harmful for user and subjects (tree/plant/soil) as well. In addition, the figures, are to have better understanding of the disclosed methods and the related systems.

Apparatuses to perform an electro-invasion treatment of a subject (trees/plants or soil), influenced by an electromagnetic field as a trees/plants or soil treatment and the related methods, are comprising, but not limited to;

The structural main frame 22, with appropriate size, strength, shape and design, which, other component will be mounted on it. The electro-magnetic coil/s 11, in operation mood, which, create the electromagnetic field surround the tree and the branches.

The discharge bar/s (or magnetic discharge bar/s) 15, controller/s kit and the distributor/s 16, are mounted on a frame 24. The electro-magnetic concentrator coil/s (or any other device which can make the magnetic field limited and concentrate to operation region) 21, are to provide a magnetic region surrounding the subject under treatment to be invaded by invasive/storm of electrons.

Wheels 19, are designed to carry the weight of the apparatus and other components. Also, some wheel/s can be provided as supported wheels 18, for support the discharge bar/s frame 24, if needed.

Extendable telescoping magnetic frame 23, designed to extend and shorten the width of the magnetic frame 23, and the other mounted component. The magnetic frame 23, and the discharge bar/s frame 24, can be assembled into transportation mood and also, can be shifted to the operating mood.

The “electro-invasion into influenced magnetic field for trees, plants and soil” apparatus can be either pulled by tractor/s, any utility vehicle/s, or can be self-propelled device. Pulling hitch point/s 25 is to attach the apparatus to a tractor or a utility vehicle.

The discharge finger/s 29F, are mounted on ground discharge system 29. The discharge finger/s 29F are to contact at least one terminal point (either Positive or Negative), directly or indirectly to the body of the subject under treatment.

The discharge finger/s 29F can be a simple disk with numbers of contact point, which connected to the soil and make a close circuit. The ground discharge wheels can be shifted into transportation mood too.

In order to optimization of the treatment and in addition to monitoring the differentiation of the parameters and the conditions during the treatment, the parameters comprising; forward speed, frequency in magnetic field and the pulsation's voltage (electro-invasion pulses), magnitude in electromagnetic field, voltage, amperage, changes in resistance and temperature during the treatment (operation), will be monitored and can be adjusted.

The required power for the electro-generator 12, or other driven parts, can be provided via P.T.O. drive of a tractor or an engine to a driven P.T.O shaft 28, designed for power transmission.

The transmitted power can be directly run the electro-generator/s 12, or other components. The batteries 14, are to store the generated electricity by the generator/s 12, although, the electricity in used can be provided from solar panel.

The discharge points 17, are located on the discharge bar/s 15, moreover, the discharge bar/s 15, has ability to provide the magnetic field by the magnetic coils located on the discharge bars 15.

It should be emphasized that the above-described embodiments of the present disclosure are merely possible examples of implementations set forth for a clear understanding of the principles of the disclosure. Many variations and modifications can be made to the above-described embodiment(s) without departing substantially from the spirit and principles of the disclosure. All such modifications and variations are intended to be included herein within the scope of this disclosure and protected by the following claims.

It should be also, noted that, the treatment and working with electricity may cause damage and serious injury or death. The user should be aware of the risk of operation on his/her own, and should follow all necessary rolls and protection which if ignored, could result in death or serious personal injury caused by incorrect operation of the equipment. Invertor specifically disclaims any implied warranty of non-infringement or merchantability or fitness for a particular purpose and will in no event be liable for any indirect, consequential, incidental, special or aggravated or other similar or like damages or losses, including any loss of profits, arising from any defect, error or failure to perform, even if it has been advised of the possibility of such damages or losses.

It should be noted that ratios, concentrations, amounts, and other numerical data can be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt% to about 5 wt%, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

### SUMMARY OF THE INVENTION

Presently, there is a willing to reduce the chemical treatment/s, especially, to eliminate the systematic chemical control/s, particularly, in organic farming. However, there is no cure for some of the crop/tree diseases like Huanglongbing so far.

The present invention is related to a method for improving plant growth and reduce the effects of diseases, with environmental friendly techniques. This is a method for controlling or ending diseases infections in tree/plants or soil.

Some of the goals which contemplated to be achieved are;

To perform a non-stop electromagnetic combine with invaded electrons treatment with its effective methods for soil, plants, trees and their roots region.

Control the insect/s, nematodes in plant, tree and in the soil under treatment.

Stimulate the crops/trees activity and increase the productivity;

Control and manage of the tree/plants dormancy, and advance or late flowering to have extra and double time off-season blooming.

Fixed attachment device for a tree to stimulate the activity and also, to combat diseases, freezing temperature, insects and animal damage.

Some of the pathogens, nematodes and insect/s in the region influenced by the magnetic field, invaded by squall of electrons, can be decontaminated after the treatment.

It should be clarified that the above-explanations of the current disclosure are merely and briefly for convenience of implementations set forth for a clear understanding of the principles of the disclosure. Several variations and modifications can be made to the above embodiment/s and explanations without passing considerably from the principles of the disclosure. All such modifications and contemplate to modifications are intended to be included herein within the scope of this disclosure and protected by the following claims. It should be noted that ratios, values, amounts, and other numerical data can be expressed herein in a range format. It is to be understood that, such a range format is used for brief and simplifying the explanation/s, and thus, it is envisaged that such range format should be interpreted in a flexible manner to comprise and coverage of all spirit and principles of this disclosure.

1. Electro-invasion Treatment for Tree/Plants or soil, Influenced by a Magnetic Field and its Methods, is disclosing, comprising but not limited to; structural design, discharge bar/s or electromagnetic discharge bar/s system, electromagnetic system, invasive electricity generator system and the controlling system.

2. The concept is flow of the invasive electrons spurted into a subject under treatment (tree/plant/soil), which, optionally, with an existing of the electromagnetic field by the time of treatment, in the treating region.

3. The discharge bar/s system according to claim 1, wherein said “discharge bar/s system” is comprising; at least one/more discharge point/s placed on it. Optionally, the discharge bar/s also, can create electromagnetic field surround itself. The discharge bar/s can optionally, equipped with, controller, distributor, and ignition coil (to generate high voltage electricity and the magnetic field), which can be configured the electro-invasion into trees, plants or soil whilst exposed to an electromagnetic field.

4. Magnetic system is to build and maintain the electromagnetic field in the region of treatment. The magnetic field's characteristics like magnitude, longitude, intensity, frequency of pulsation, and the rhythm pulsation can be control by the controlling system.

5. Invasive electricity generator system, according to claim 1, is comprising; electro-generator, electro-invasion system, is to generate invasive electricity as squall of electrons. The electricity current as electro-invasion can be very high voltage low amperage electricity.

6. Controlling system, according to claim 1, is system and method to maintain the uniformity of treatment, electrons transfer rate to the subject (tree/plant tissues and alive or textural soil particles), and the system to control of the pulses rhythm (of both magnetic field and the invasive electricity). Furthermore, sensor/s and controller/s are to control the voltage, amperage, duration and the frequency of pulsation.

7. The controller system can also, controls the characteristics of magnetic field in the magnetic coils (at main magnetic coils and the discharge magnetic coils), like; magnitude, longitude, intensity, frequency of pulsation, the rhythm pulsation and direction of electrons movement.

8. The controller kit/s is used to monitor the resistance against electrons flow, and the temperature of device as well as the subjects under treatment. The controller kit/s can be as simple as a device to change the current parameters.

9. An electricity-magnetic tree attachment apparatus comprises but not limited to; at least a magnet bar, discharge point/s and potentially a controller attached to the tree.

10. Electricity-magnetic tree attachment, according to claim 8, wherein said “magnetic bar” can be an electromagnetic (or even a natural magnet) bar/s in which, influenced the trunk by an electromagnetic field, and can be extended to some of the tree branches. The electricity current using in an electricity-magnetic tree attachment, can be pulsation of AC/DC current with all possibly adjustment of characteristics of the electricity current and the created magnetic field. The current can be weaken electricity current (high voltage/low amperage).

11. The apparatus for electro-invasion treatment for plant or row plants is as same concept as the apparatus for trees. The differences are in scale of apparatus, the characteristics of the electromagnetic field and the characteristics of invaded electrons.

12. Alternatively, the negative terminal of the DC/AC voltage source can be connected to the discharge bar/s, and electrons flow through a controller and distribution unit while the positive terminal of the DC/AC can be connected to the ground terminal. The electricity source can be a generator or from solar panel/s.
